(19) United States
(12) Patent Application Publication
(10) Pub. No.: US 2026/0116219 A1
(43) Pub. Date: Apr. 30, 2026

(54) POLYMER BINDER INCLUDING A TAG FOR USE IN ELECTROCHEMICAL CELLS

(71) Applicant: GM Global Technology Operations LLC, Detroit, MI (US)

(72) Inventors: Nathaniel Hardin, Farmington Hills, MI (US); Yifan Zhao, Troy, MI (US); Sanaz Ketabi, Rochester Hills, MI (US); Kyungjae Lee, Rochester Hills, MI (US)

(21) Appl. No.: 18/928,774

(22) Filed: Oct. 28, 2024

(51) Int. Cl. B60L 50/64; C08B 15/06; C08C 19/28; C08F 8/32; G01N 21/64; H01M 4/62

(52) U.S. Cl. CPC B60L 50/64; C08B 15/06; C08C 19/28; C08F 8/32; G01N 21/643; H01M 4/622; G01N 2021/6439; H01M 2220/20

(57) ABSTRACT

An electrode material including an active material; a non-fluorinated polymer binder that includes a detectable label; and a conductive filler.

### INTRODUCTION

The subject disclosure relates to battery cell technologies, and particularly to polymer binders for electrodes in electrochemical cells.

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

The electrodes in a battery are one of the key components responsible for the electrochemical reactions that occur during charging and discharging processes. Modern automotive high voltage battery packs benefit from high energy density electrodes to improve overall performance and range. However, there remains a continuing need for fluorine-free polymer binder materials, and the associated ability to quantitively determine the distribution and eventual migration of the polymer binder in the electrode material during assembly and then operation of the battery.

### SUMMARY

An aspect provides an electrode material. The electrode material includes an active material; a non-fluorinated polymer binder that includes a detectable label; and a conductive filler.

In another embodiment of the electrode material, the detectable label of the non-fluorinated polymer binder is bonded to a backbone of the polymer binder or as an end group of the backbone of the polymer binder.

In another embodiment of the electrode material, the backbone of the non-fluorinated polymer binder is a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone.

In another embodiment of the electrode material, the non-fluorinated polymer binder is prepared by reacting a functional group of the backbone of the polymer binder with a detectable reagent to form the detectable label that is bonded to the backbone of the polymer binder.

In another embodiment of the electrode material, the detectable label includes fluorescein or a derivative thereof, rhodamine or a derivative thereof, acridine or a derivative thereof, coumarin or a derivative thereof, eosin or a derivative thereof, erythrosine or a derivative thereof, pyrene or a derivative thereof, or a combination thereof.

In another embodiment of the electrode material, the non-fluorinated polymer binder further includes a linking group connecting the backbone to the detectable label.

In another embodiment of the electrode material, the electrode material excludes a fluorinated binder.

Another aspect provides an electrochemical cell that includes a positive electrode; a negative electrode; and an electrolyte. At least one of the positive electrode or the negative electrode includes the electrode material as described herein.

In another embodiment of the electrochemical cell, the detectable label is bonded to a backbone of the polymer binder or as an end group of the backbone of the polymer binder.

In another embodiment of the electrochemical cell, the backbone is a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone.

In another embodiment of the electrochemical cell, the polymer binder is prepared by reacting a functional group of the backbone of the polymer binder with a detectable reagent to form the detectable label that is bonded to the backbone of the polymer binder.

In another embodiment of the electrochemical cell, the detectable label includes fluorescein or a derivative thereof, rhodamine or a derivative thereof, acridine or a derivative thereof, coumarin or a derivative thereof, eosin or a derivative thereof, erythrosine or a derivative thereof, pyrene or a derivative thereof, or a combination thereof.

In another embodiment of the electrochemical cell, the non-fluorinated polymer binder further includes a linking group connecting the backbone to the detectable label.

In another embodiment of the electrochemical cell, the electrode material excludes a fluorinated binder.

Still another aspect provides a method of measuring a distribution of a binder in an electrode material. The method includes providing the electrode material as described herein, exposing the electrode material to activating radiation sufficient to provide a quantitative signal from the detectable label; and determining a distribution of the non-fluorinated polymer binder according to the quantitative signal from the detectable label.

In another embodiment of the method, the method further includes charging and discharging a electrochemical cell comprising the electrode material before the step of providing the electrode material.

In another embodiment of the method, the detectable label is bonded to a backbone of the polymer binder or as an end group of the backbone of the polymer binder.

In another embodiment of the method, the backbone is a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone.

In another embodiment of the method, the polymer binder is prepared by reacting a functional group of the backbone of the polymer binder with a detectable reagent to form the detectable label that is bonded to the backbone of the polymer binder.

In another embodiment of the method, the electrode material excludes a fluorinated binder.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle configured in accordance with one or more embodiments;

FIG. 2 schematically illustrates an exemplary electrochemical cell (battery) including the disclosed electrode material, in accordance with the present disclosure;

FIG. 3A is a visual image, using a scalar bar of 100 micrometers (μm), of an example of the electrode material;

FIG. 3B is a visual image, using a scalar bar of 100 μm, of an example of the electrode material; and

FIG. 3C is a visual image, using a scalar bar of 100 μm, of an example of the electrode material.

### DETAILED DESCRIPTION

The following description is merely exemplary in nature and is not intended to limit the present disclosure, its application, or uses. It should be understood that throughout the drawings, corresponding reference numerals indicate like or corresponding parts and features. As used herein, the terms “anode” and “negative electrode” are used interchangeably, and the terms “cathode” and “positive electrode” are used interchangeably.

The present technology pertains to improved electrochemical cells (e.g., battery cells), especially lithium-ion, or more particularly lithium-metal batteries, which may be used in vehicle applications. However, the present technology may also be used in other electrochemical devices, such as sodium ion batteries, so that the discussion of a lithium-ion battery herein is non-limiting.

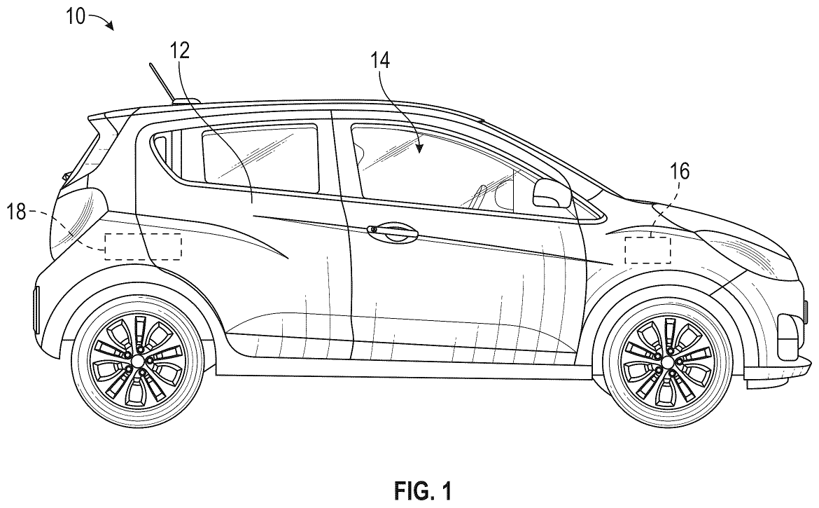

A vehicle, in accordance with an exemplary embodiment, is indicated generally at 10 in FIG. 1. Vehicle 10 is shown in the form of an automobile having a body 12. Body 12 includes a passenger compartment 14 within which are arranged a steering wheel, front seats, and rear passenger seats (not separately indicated). Within the body 12 are arranged a number of components, including, for example, an electric motor 16 (shown by projection under the front hood). The electric motor 16 is shown for ease of illustration and discussion only. It should be understood that the configuration, location, size, arrangement, etc., of the electric motor 16 is not meant to be particularly limited, and all such configurations (including multi-motor configurations) are within the contemplated scope of this disclosure.

The electric motor 16 is powered via a battery pack 18 (shown by projection near the rear of the vehicle 10). The battery pack 18 is shown for ease of illustration and discussion only. It should be understood that the configuration, location, size, arrangement, etc., of the battery pack 18 is not meant to be particularly limited, and all such configurations (including split configurations) are within the contemplated scope of this disclosure. Moreover, while the present disclosure is discussed primarily in the context of a battery pack 18 configured for the electric motor 16 of the vehicle 10, aspects described herein can be similarly incorporated within any system (vehicle, building, or otherwise) having an energy storage system(s) (e.g., one or more battery packs or modules), and all such configurations and applications are within the contemplated scope of this disclosure.

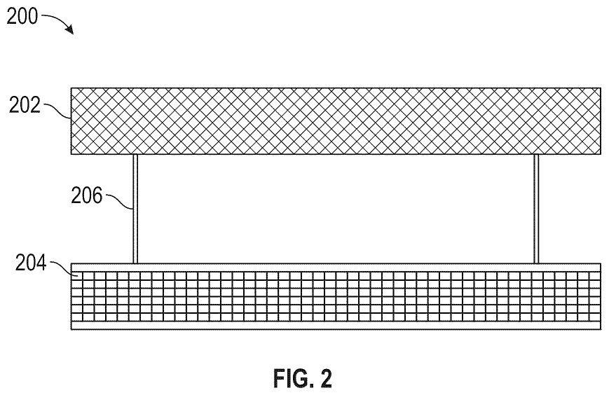

As discussed previously, in some embodiments, the battery pack 18 includes an electrochemical cell or battery that includes a positive electrode, a negative electrode, and an electrolyte. Also provided is an electrochemical cell including a cathode, an anode, and an electrolyte located between the cathode and the anode. FIG. 2 illustrates a simplified configuration of an electrochemical cell of a battery pack (e.g., the battery pack 18 of FIG. 1) in accordance with one or more embodiments. As shown in FIG. 2, an electrochemical cell 200 can include a cathode 202 (i.e., a positive electrode), an anode 204 (i.e., a negative electrode), and an electrolyte 206 that is located between the cathode 202 and the anode 204. While only a single electrochemical cell 200 is shown for convenience, it should be understood that a battery pack may include any number of cells as needed to meet battery design constraints (e.g., capacity requirements). At least one of the positive electrode (cathode 202) or the negative electrode (anode 204) includes the electrode material as provided herein.

An aspect provides an electrode material. The electrode material includes an active material, a non-fluorinated polymer binder comprising a detectable label, and a conductive filler. The electrode material may be a cathode material or an anode material. For example, one or both of the cathode material and the anode material may include the non-fluorinated polymer binder comprising a detectable label. In some embodiments, the electrode material may exclude a fluorinated binder. For example, one or both of the cathode material and the anode material may include the non-fluorinated polymer binder comprising a detectable label, and one or both of the cathode material and the anode material may exclude a fluorinated binder.

The non-fluorinated polymer binder includes a detectable label. The detectable label provides a signal generator, which is a molecule or moiety that is capable of providing a detectable signal using one or more detection techniques (e.g., spectrometry, calorimetry, spectroscopy, or visual inspection). Suitable examples of a detectable signal may include an optical signal, and electrical signal, or a radioactive signal. Examples of signal generators useful in the inventive methods include, for example, a chromophore, a fluorophore, a Raman-active tag, a radioactive label, an enzyme, an enzyme substrate, or combinations thereof. For example, the detectable label may be a luminescent tag, a fluorescent tag, or a combination thereof (which may collectively be referred to as a fluorophore, as described herein).

Suitable radioisotopes may include H-3, C-11, C-14, F-18, P-32, S-35, I-123, I-124, I-125, I-131, Cr-51, C1-36, Co-57, Fe-59, Se-75, and Eu-152. Isotopes of halogens (such as chlorine, fluorine, bromine, and iodine), and metals including technetium, yttrium, rhenium, and indium are also useful labels. Typical examples of metallic ions that may be used as signal generators include Tc-99m, I-123, In-111, I-131, Ru-97, Cu-67, Ga-67, I-125, Ga-68, As-72, Zr-89, Gd-153 and TI-201. Radioisotopes for in vivo diagnostic imaging by positron emission tomography (“PET”) include C-11, F-18, Ga-68 and I-124. Paramagnetic labels may be metal ions that are present in the form of metal complexes or metal oxide particles. Suitable paramagnetic isotopes may include Gd-157, Mn-55, Dy-162, Cr-52, and Fe-56.

As used herein the term “paramagnetic metal ion,” “paramagnetic ion” or “metal ion” refers to a metal ion that is magnetized parallel or antiparallel to a magnetic field to an extent proportional to the field. Generally, these are metal ions that have unpaired electrons. Examples of suitable paramagnetic metal ions, include, but are not limited to, gadolinium III, iron III, manganese II, yttrium III, dysprosium III, and chromium III.

In some embodiments, the detectable label may be a fluorophore. As used herein, the term “fluorophore” refers to a chemical compound or moiety, which when excited by exposure to a particular wavelength of light, emits light (at a different wavelength). Fluorophores may be described in terms of their emission profile, or “color.” Green fluorophores (for example Cy3, FITC, and Oregon Green) may be characterized by their emission at wavelengths generally in the range of 515-540 nanometers. Red fluorophores (for example Texas Red, Cy5, and tetramethylrhodamine) may be characterized by their emission at wavelengths generally in the range of 590-690 nanometers. Examples of fluorophores include, but are not limited to, 4-acetamido-4′-isothiocyanatostilbene-2,2′disulfonic acid, acridine, derivatives of acridine and acridine isothiocyanate, 5-(2′-aminoethyl)aminonaphthalene-1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide, anthranilamide, Brilliant Yellow, coumarin, coumarin derivatives, 7-amino-4-methylcoumarin (AMC, Coumarin 120), 7-amino-trifluoromethylcouluarin (Coumarin 151), cyanosine; 4′,6-diaminidino-2-phenylindole (DAPI), 5′,5″-dibromopyrogallol-sulfonephthalein (Bromopyrogallol Red), 7-diethylamino-3-(4′-isothiocyanatophenyl)-4-methylcoumarin, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), eosin, derivatives of eosin such as eosin isothiocyanate, erythrosine, derivatives of erythrosine such as erythrosine B and erythrosin isothiocyanate; ethidium; fluorescein and derivatives such as 5-carboxyfluorescein (FAM), 5-(4,6-dichlorotriazin-2-yl) aminofluorescein (DTAF), 2′7′-di methoxy-4′5′-dichloro-6-carboxyfluorescein (JOE), fluorescein, fluorescein isothiocyanate (FITC), QFITC (XRITC); fluorescamine derivatives (fluorescent upon reaction with amines); IR144; IR1446; Malachite Green isothiocyanate; 4-methylumbelliferone; ortho cresolphthalein; nitrotyrosine; pararosaniline; Phenol Red, B-phycoerythrin; o-phthaldialdehyde derivative (fluorescent upon reaction with amines); pyrene and derivatives such as pyrene, pyrene butyrate and succinimidyl 1-pyrene butyrate; Reactive Red 4 (Cibacron® Brilliant Red 3B-A), rhodamine and derivatives such as 6-carboxy-X-rhodamine (ROX), 6-carboxyrhodamine (R6G), lissamine rhodamine B sulfonyl chloride, rhodamine (Rhod), rhodamine B, rhodamine 123, rhodamine X isothiocyanate, sulforhodamine B, sulforhodamine 101 and sulfonyl chloride derivative of sulforhodamine 101 (Texas Red); N,N,N′,N′-tetramethyl-6-carboxyrhodamine (TAMRA); tetramethyl rhodamine, tetramethyl rhodamine isothiocyanate (TRITC); riboflavin; biotin; rosolic acid and lathanide chelate derivatives, quantum dots, cyanines, and squaraines. In some embodiments, the detectable label may include fluorescein or a derivative thereof, rhodamine or a derivative thereof, acridine or a derivative thereof, coumarin or a derivative thereof, eosin or a derivative thereof, erythrosine or a derivative thereof, pyrene or a derivative thereof, or a combination thereof.

In some embodiments, the detectable label may be bonded to a backbone of the polymer binder or as an end group of the backbone of the polymer binder. Preferably, the detectable label is bonded to a backbone of the polymer binder. The detectable label may be bonded to the backbone of the polymer binder via a direct covalent bond or via one or more divalent linking groups. As used herein, when a definition is not otherwise provided, a “divalent linking group” refers to a divalent group including one or more of —O—, —S—, —C(O)—, —C(O)O—, —N(R′)—, —C(O)N(R′)—, —S(O)—, —S(O)₂—, substituted or unsubstituted C₁₋₃₀ alkylene, substituted or unsubstituted C₃₋₃₀ cycloalkylene, substituted or unsubstituted C₃₋₃₀ heterocycloalkylene, substituted or unsubstituted C₆₋₃₀ arylene, substituted or unsubstituted C₃₋₃₀ heteroarylene, or a combination thereof, wherein each R′ is independently hydrogen, substituted or unsubstituted C₁₋₂₀ alkyl, substituted or unsubstituted C₁₋₂₀ heteroalkyl, substituted or unsubstituted C₆₋₃₀ aryl, or substituted or unsubstituted C₃₋₃₀ heteroaryl. Typically, the divalent linking group includes one or more of —O—, —S—, —C(O)—, —C(O)O—, —N(R′)—, —C(O)N(R′)—, —S(O)—, —S(O)₂—, substituted or unsubstituted C₁₋₃₀ alkylene, substituted or unsubstituted C₃₋₃₀ cycloalkylene, substituted or unsubstituted C₃₋₃₀ heterocycloalkylene, substituted or unsubstituted C₆₋₃₀ arylene, substituted or unsubstituted C₃₋₃₀ heteroarylene, or a combination thereof, wherein R′ is hydrogen, substituted or unsubstituted C₁₋₂₀ alkyl, substituted or unsubstituted C₁₋₂₀ heteroalkyl, substituted or unsubstituted C₆₋₃₀ aryl, or substituted or unsubstituted C₃₋₃₀ heteroaryl. More typically, the divalent linking group includes at least one of —O—, —C(O)—, —C(O)O—, —N(R′)—, —C(O)N(R′)—, substituted or unsubstituted C₁₋₁₀ alkylene, substituted or unsubstituted C₃₋₁₀ cycloalkylene, substituted or unsubstituted C₃₋₁₀ heterocycloalkylene, substituted or unsubstituted C₆₋₁₀ arylene, substituted or unsubstituted C₃₋₁₀ heteroarylene, or a combination thereof, wherein R is hydrogen, substituted or unsubstituted C₁₋₁₀ alkyl, substituted or unsubstituted C₁₋₁₀ heteroalkyl, substituted or unsubstituted C₆₋₁₀ aryl, or substituted or unsubstituted C₃₋₁₀ heteroaryl.

“Substituted” means that at least one hydrogen atom of the chemical structure or group is replaced with another terminal substituent group that is typically monovalent, provided that the designated atom's normal valence is not exceeded. Exemplary substituent groups that may be present on a “substituted” position include, but are not limited to, nitro (—NO₂), cyano (—CN), hydroxyl (—OH), oxo (O), amino (—NH₂), mono- or di-(C₁₋₆)alkylamino, C₂₋₆ alkanoyl (e.g., acyl), formyl (—C(O)H), carboxylic acid or an alkali metal or ammonium salt thereof; C₂₋₆ alkyl esters (—C(O)O-alkyl or —OC(O)-alkyl), C₇₋₁₃ aryl esters (—C(O)O-aryl or —OC(O)-aryl); amido (—C(O)NR₂ wherein each R is hydrogen or C₁₋₆ alkyl), carboxamido (—CH₂C(O)NR₂ wherein each R is hydrogen or C₁₋₆ alkyl), halogen, thiol (—SH), C₁₋₆ alkylthio (—S-alkyl), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₂₋₁₈ heterocycloalkenyl, C₆₋₁₂ aryl having at least one aromatic ring (e.g., phenyl, biphenyl, naphthyl, or the like, each ring either substituted or unsubstituted aromatic), C₇₋₁₉ arylalkyl, arylalkoxy, C₇₋₁₂ alkylaryl, C₃₋₁₂ heterocycloalkyl, C₃₋₁₂ heteroaryl, C₁₋₆ alkyl sulfonyl (—S(O)₂-alkyl), and/or C₆₋₁₂ arylsulfonyl (—S(O)₂-aryl).

The detectable label may be included in the polymer structure in any appropriate amount. For example, the polymer binder may include the detectable label in an amount from 0.01 to 10 wt %, or 0.1 to 5 wt %, or 0.1 to 2 wt %, based on total weight of the polymer binder.

The polymeric binder includes a backbone structure. For example, in some embodiments, the backbone may be a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone, but embodiments are not limited thereto and any suitable polymeric binder may be used. The polymeric backbone structure may be further modified to include, or may inherently include, a functional group to facilitate the bonding of the detectable label. Any suitable functional group may be used and/or included. Exemplary functional groups include, but are not limited to, hydroxyl, thiol, isocyanate, isothiocyanate, ester, carbonyl, acid halide, epoxy, amide, alkene, or a combination thereof.

The non-fluorinated polymer binder may be prepared using any suitable methods in the art, including those exemplified by the working examples. For example, the non-fluorinated polymer binder may be prepared by reacting a functional group of the backbone of the polymer binder with a detectable reagent to form the detectable label that is bonded to the backbone of the polymer binder. For example, the non-fluorinated polymer binder may be prepared by reacting a functional group of the backbone of the polymer binder with a fluorophore to form the detectable label that is bonded to the backbone of the polymer binder, which may be bonded to the backbone via one or more divalent linking groups as described herein.

In some embodiments, the non-fluorinated polymer binder may be prepared by reacting a polysaccharide-containing polymer, such as a carboxymethyl cellulose (CMC) backbone, a styrene-butadiene rubber carboxymethyl cellulose (SBR-CMC) backbone, or the like, with a fluorophore using isothiocyanate coupling, carbonyl coupling chemistry, or isocyanate coupling. In some embodiments, the non-fluorinated polymer binder may be prepared by reacting a carbonyl-containing polymer, such as a poly(acrylic acid) (PAA) backbone, or the like, with an amine-containing fluorophore. In some embodiments, the non-fluorinated polymer binder may be prepared by reacting a alkene-containing polymer, such as a styrene-butadiene rubber (SBR) backbone, a styrene-butadiene rubber carboxymethyl cellulose (SBR-CMC) backbone, or the like with a fluorophore using radical grafting, thiol-ene coupling, or a Diels-Alder reaction.

Also provided is an electrochemical cell including a cathode, an anode, and an electrolyte located between the cathode and the anode. As described above, FIG. 2 illustrates a simplified configuration of an electrochemical cell of a battery pack (e.g., the battery pack 18 of FIG. 1) in accordance with one or more embodiments.

In some embodiments, the active material (also referred to as electroactive material) of the cathode 202 may include a lithium-containing active material that can sufficiently undergo lithium intercalation and deintercalation, alloying and dealloying, and/or plating and stripping, while functioning as the positive terminal of the electrochemical cell 200. The cathode 202 electroactive materials may include one or more transition metals, such as manganese (Mn), nickel (Ni), cobalt (Co), chromium (Cr), iron (Fe), vanadium (V), or a combination thereof. Exemplary lithium-containing active materials include spinel lithium manganese oxide (LiMn₂O₄), lithium cobalt oxide (LiCoO₂), a nickel-manganese oxide spinel (Li(Ni_{0.5}Mn_{1.5})O₂), a layered nickel-manganese-cobalt oxide (having a general formula of xLi₂MnO₃ (1−x)LiMO₂, where M is composed of any ratio of Ni, Mn, and/or Co). A specific example of the layered nickel-manganese oxide spinel is xLi₂MnO₃ (1−x)Li(Ni_{1/3}Mn_{1/3}CO_{1/3})O₂. Other exemplary lithium-containing cathode active materials include Li(Ni_{1/3}Mn_{1/3}CO_{1/3})O₂), LiNiO₂, Liₓ+yMn₂−yO₄ (LMO, 0<x<1 and 0<y<0.1), a lithium iron polyanion oxide, such as lithium iron phosphate (LiFePO₄) or lithium iron fluorophosphate (Li₂FePO₄F, LFP), or a combination thereof. Other lithium-containing cathode active materials may also be used, such as LiNiₓM₁₋ₓO₂ (M is composed of any ratio of Al, Co, and/or Mg), LiNi₁₋ₓCo_{1-y}M_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LiₓMn₂₋ₓAl_{y}O₄), NCMA (LiNi_{1-x-y-z}CoₓMn_{y}Al_{z}O₂) (where 0.02≤x≤0.20, 0.01≤y≤0.12, and 0.01≤z≤0.08), lithium vanadium oxide (LiV₂O₅), Li₂MSiO₄ (M is composed of any ratio of Co, Fe, and/or Mn), a high efficiency nickel-manganese-cobalt material (HE-NMC, NMC, or LiNiMnCoO₂), an olivine LiMnₓFe₍₁₋ₓ₎PO₄ (LMFP), or the like, or a combination thereof. By “any ratio” it is meant that any element may be present in any amount. In another example, anion substitutions may be made in the lattice of any example of the lithium transition metal active material to stabilize the crystal structure. For example, any O atom may be substituted with an F atom. In some embodiments, the cathode includes NCM 111, NCM 532, NCM 622, NCM 712, NCM 811, NCMA, NCA, LNMO, or combination thereof. In some embodiments, the cathode includes NCMA.

In some embodiments, the electrolyte 206 functions as a separator to provide a physical barrier between the cathode 202 and the anode 204. In some embodiments, the electrolyte 206 includes a dendrite-blocking layer, one or more interface layers, and/or one or more electrolyte layers (not separately shown). In some embodiments, the electrolyte 206, in addition to providing a physical barrier between the cathode 202 and the anode 204, can provide a minimal resistance path for the internal passage of lithium ions (and related anions) during cycling of the lithium ions to facilitate functioning of the electrochemical cell 200.

The electrolyte 206 provides a medium for the conduction of lithium ions through the electrochemical cell 200 between the cathode 202 and the anode 204 and may be in solid, liquid, or gel form. In aspects, the electrolyte 206 may include a non-aqueous liquid electrolyte solution including a lithium salt dissolved in a non-aqueous aprotic organic solvent or a mixture of non-aqueous aprotic organic solvents. Non-limiting examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C2O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G₃)(TFSI), lithium bis(trifluoromethanesulfonyl)azanide (LiTFSA), and combinations thereof. Non-limiting examples of non-aqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ lactones (e.g., γ butyrolactone, γ valerolactone), chain structure ethers (e.g., 1,2 dimethoxyethane, 1 2 diethoxyethane, ethoxymethoxyethane), cyclic ethers (e.g., tetrahydrofuran, 2 methyltetrahydrofuran), 1,3-dioxolane), or the like.

In some embodiments, the electrolyte may be a solid-state electrolyte. The solid-state electrolyte may include one or more solid-state electrolyte particles that may include one or more polymer-containing particles, oxide-containing particles, sulfide-containing particles, halide-containing particles, borate-containing particles, nitride-containing particles, hydride-containing particles, or a combination thereof. Exemplary solid-state electrolytes include, but are not limited to, LiTi₂(PO₄)₃, LiGe₂(PO₄)₃, Li₇La₃Zr₂O₁₂, Li₃xLa_{2/3}−xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or a combination thereof.

In some embodiments, the anode 204 includes an electroactive material such as a lithium host material capable of functioning as a negative terminal of the electrochemical cell 200. In various aspects, the electroactive material includes lithium and may be a lithium metal. In some embodiments, the anode 204 can include an electroactive lithium host material, such as graphite. In some embodiments, the anode 204 can include an electrically conductive material, as well as one or more polymeric binder materials to structurally hold the graphite material together. For example, the negative electrode may include the polymer binder as disclosed herein.

Negative electrodes may comprise greater than or equal to about 50% to less than or equal to about 100% of an electroactive material (e.g., graphite or graphite and lithiated silicon oxide blend), optionally less than or equal to about 30% of an electrically conductive material, and a balance binder. For example, in some embodiments, the anode 204 may include an active material including graphite particles intermingled with a binder material. When the binder material is not the non-fluorinated polymer binder comprising a detectable label, it may be polyvinylidene difluoride (PVdF), ethylene propylene diene monomer (EPDM) rubber, and/or carboxymethoxyl cellulose (CMC), a styrene-butadiene rubber (SBR), a compound and/or mixture of CMC and SBR, a nitrile butadiene rubber (NBR), lithium polyacrylate (LiPAA), sodium polyacrylate (NaPAA), sodium alginate, lithium alginate, and combinations thereof, by way of non-limiting examples. Suitable additional electrically conductive materials may include carbon-containing material and/or a conductive polymer. Carbon-containing materials may include, for example, electrically conductive carbon black, electrically conductive acetylene black, acetylene black, carbon black, graphite, graphene, graphene oxides, carbon nanofibers, carbon nanotubes, or the like. Examples of a conductive polymer include polyaniline, polythiophene, polyacetylene, polypyrrole, or the like. In certain aspects, mixtures of these conductive materials may be used.

In some embodiments, the cathode material, or material used to prepare the cathode, may include a solvent, a binder, and/or a slurry stabilizing agent (not separately shown). Solvents can be selected from known materials depending on the choice in the cathode active material. For example, the solvent for NCMA active materials may include N-Methyl-2-pyrrolidone (NMP). Other solvents, such as cyclic carbonates (e.g., ethylene carbonate (EC), propylene carbonate (PC), butylene carbonate (BC), fluoroethylene carbonate (FEC)); acyclic (i.e., linear) carbonates (e.g., dimethyl carbonate (DMC), diethyl carbonate (DEC), ethylmethylcarbonate (EMC)); aliphatic carboxylic esters (e.g., methyl formate, methyl acetate, methyl propionate); γ-lactones (e.g., γ-butyrolactone, γ-valerolactone); chain structure ethers (e.g., 1,2-dimethoxyethane, 1-2-diethoxyethane, ethoxymethoxyethane); cyclic ethers (e.g., tetrahydrofuran, 2-methyltetrahydrofuran, 1,3-dioxolane); or combination thereof, may be used.

The cathode active material may be intermingled with a binder and/or a conductive filler. In some embodiments, the binder for the cathode active material may be the inventive non-fluorinated polymer binder that includes the detectable label. In other embodiments, the binder for the cathode active material may be another binder, such as polyvinylidene fluoride (PVdF), polyethylene oxide (PEO), an ethylene propylene diene monomer (EPDM) rubber, carboxymethyl cellulose (CMC)), styrene-butadiene rubber (SBR), styrene-butadiene rubber carboxymethyl cellulose (SBR-CMC), polyacrylic acid (PAA), cross-linked polyacrylic acid-polyethylenimine, polyimide, polyvinyl alcohol (PVA), sodium alginate, a combination thereof, or other suitable binders. An example of the conductive filler is a high surface area carbon, such as acetylene black, or the like. The binder may hold the electrode materials together, and the conductive filler may ensure good electron conduction between the positive-side current collector and the active material particles of the cathode.

In some embodiments, the electrochemical cell may further include a separator (not shown). Exemplary separators include a polymeric film, such as a polypropylene film or a coated polypropylene film. The separator may include a polyolefin-containing material having the general formula (CH₂CH_{R})ₙ, where R is an alkyl group. In some embodiments, the separator may include a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the separator include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene.

The current collector of the cathode and/or the anode may be any suitable electrically conductive material. For example, current collector may include copper, nickel, titanium, platinum, gold, silver, magnesium, aluminum, vanadium, an alloy thereof, or a combination thereof. The current collector may have a thickness of 10 nanometers (nm) to 1000 nm. For example, the current collector may have a thickness of 10 nm to 500 nm, or 50 nm to 400 nm, or 100 nm to 400 nm, but embodiments are not limited thereto.

Also provided is a method of measuring a distribution of a binder in an electrode material including providing the electrode material as disclosed herein; exposing the electrode material to activating radiation sufficient to provide a quantitative signal from the detectable label; and determining a distribution of the non-fluorinated polymer binder according to the quantitative signal from the detectable label.

In some embodiments, the method may further include determining the distribution of the binder in the electrode material before the electrode material is used in the operation of an electrochemical cell. In other embodiments, the method may further include charging and discharging a electrochemical cell that includes the electrode material before the step of providing the electrode material. The electrochemical cell may be charged and discharged for any number of cycles before the distribution of the non-fluorinated polymer binder may be determined as provided herein.

In terms of hardware architecture, the quantitative signal from the detectable label and the determination of the distribution of the non-fluorinated polymer binder can be implemented in part using a computing device that can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed. The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set), or generally any device for executing software.

The memory can include any one or combination of volatile memory elements (e.g., random access memory (RAM, such as DRAM, SRAM, SDRAM, VRAM, etc.)) and/or nonvolatile memory elements (e.g., ROM, hard drive, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates, and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

### Examples

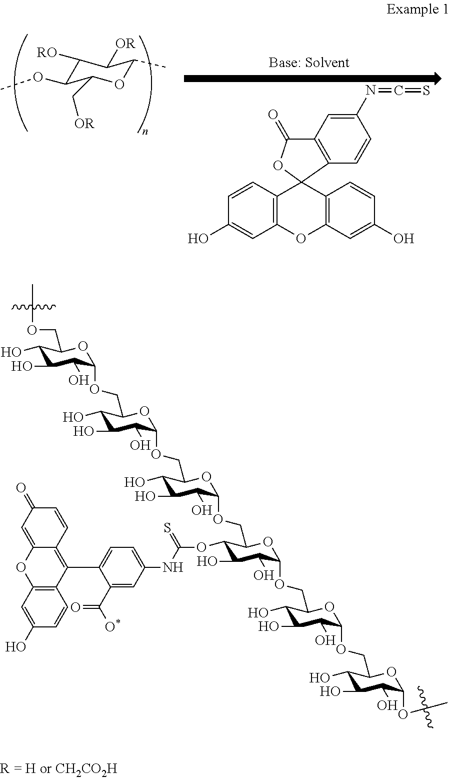

In one example, CMC may be reacted directly with isothiocyanate-functionalized FITC in a solvent. The resulting polymer binder may include 0.1 wt % of FITC label incorporated onto the backbone of the CMC polymer.

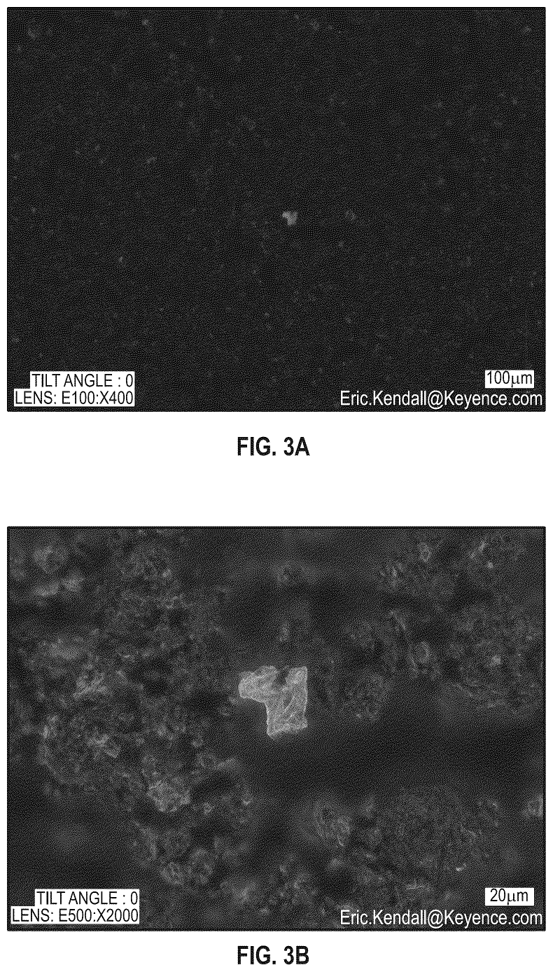

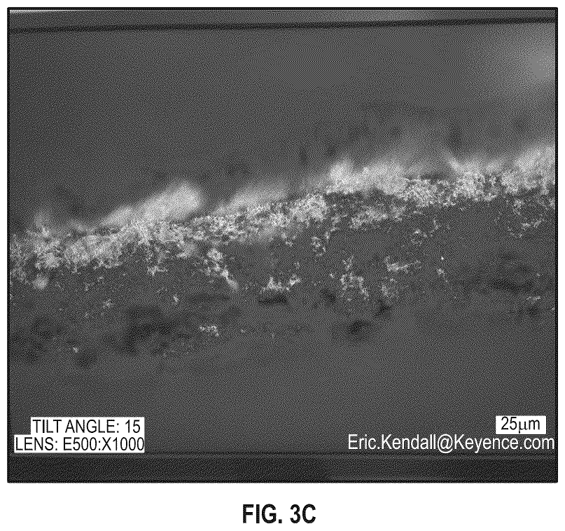

Shown in FIGS. 3A, 3B, and 3C are exemplary fluorescent images that may be obtained for an electrode that includes the labeled polymer binder prepared in Example 1. The images may be used quantitatively to determine the distribution of the polymer binder in the electrode.

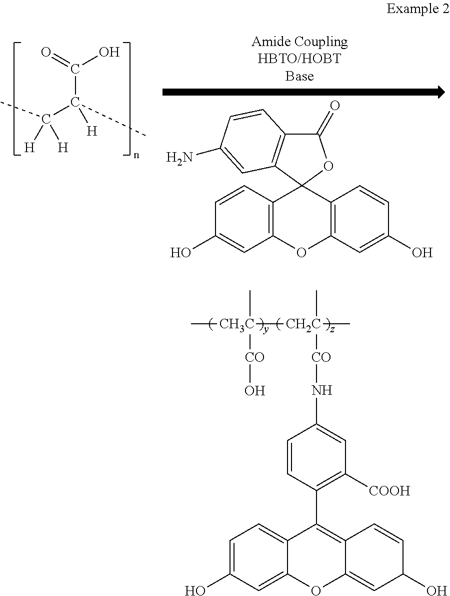

In a second example, PAA may be reacted directly with amino-functionalized FITC in a solvent. The resulting polymer binder may include 0.1 wt % of FITC label incorporated onto the backbone of the PAA polymer.

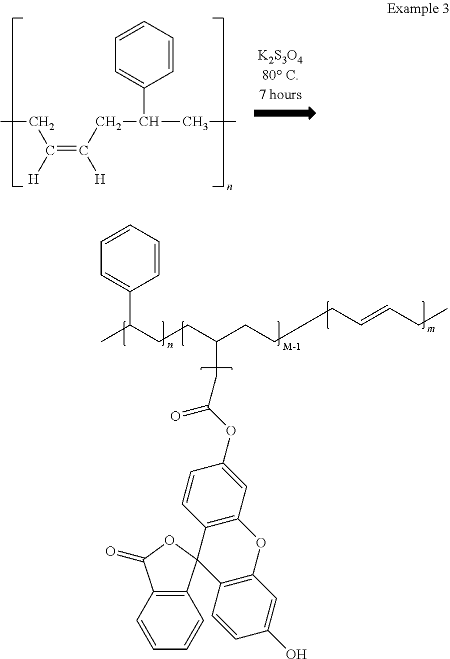

In a third example, SBR may be reacted directly with an alkene-functionalized FITC in a solvent. The resulting polymer binder may include 0.1 wt % of FITC label incorporated onto the backbone of the SBR polymer.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise

The terms “a” and “an” do not denote a limitation of quantity, but rather denote the presence of at least one of the referenced items. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears. Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. An electrode material, comprising:
an active material;
a non-fluorinated polymer binder comprising a detectable label; and
a conductive filler.

2. The electrode material of claim 1, wherein the detectable label is bonded to a backbone of the polymer binder or as an end group of the backbone of the polymer binder.

3. The electrode material of claim 1, wherein the backbone is a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone.

4. The electrode material of claim 1, wherein the non-fluorinated polymer binder is prepared by reacting a functional group of the backbone of the polymer binder with a detectable reagent to form the detectable label that is bonded to the backbone of the polymer binder.

5. The electrode material of claim 1, wherein the detectable label comprises fluorescein or a derivative thereof, rhodamine or a derivative thereof, acridine or a derivative thereof, coumarin or a derivative thereof, eosin or a derivative thereof, erythrosine or a derivative thereof, pyrene or a derivative thereof, or a combination thereof.

6. The electrode material of claim 1, further comprising a linking group connecting the backbone to the detectable label.

7. The electrode material of claim 1, excluding a fluorinated binder.

8. An electrochemical cell, comprising:
a positive electrode;
a negative electrode; and
an electrolyte,
wherein at least one of the positive electrode or the negative electrode comprises the electrode material of claim 1.

9. The electrochemical cell of claim 8, wherein the detectable label is bonded to a backbone of the polymer binder or as an end group of the backbone of the polymer binder.

10. The electrochemical cell of claim 8, wherein the backbone is a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone.

11. The electrochemical cell of claim 8, wherein the polymer binder is prepared by reacting a functional group of the backbone of the polymer binder with a detectable reagent to form the detectable label that is bonded to the backbone of the polymer binder.

12. The electrochemical cell of claim 8, wherein the detectable label comprises fluorescein or a derivative thereof, rhodamine or a derivative thereof, acridine or a derivative thereof, coumarin or a derivative thereof, eosin or a derivative thereof, erythrosine or a derivative thereof, pyrene or a derivative thereof, or a combination thereof.

13. The electrochemical cell of claim 8, further comprising a linking group connecting the backbone to the detectable label.

14. The electrochemical cell of claim 8, excluding a fluorinated binder.

15. A method of measuring a distribution of a binder in an electrode material, the method comprising:
providing the electrode material of claim 1;
exposing the electrode material to activating radiation sufficient to provide a quantitative signal from the detectable label; and
determining a distribution of the non-fluorinated polymer binder according to the quantitative signal from the detectable label.

16. The method of claim 15, further comprising charging and discharging a electrochemical cell comprising the electrode material before the step of providing the electrode material.

17. The method of claim 15, wherein the detectable label is bonded to a backbone of the polymer binder or as an end group of the backbone of the polymer binder.

18. The method of claim 15, wherein the backbone is a carboxymethyl cellulose (CMC) backbone, a poly(acrylic acid) (PAA) backbone, a styrene-butadiene rubber (SBR) backbone, or a styrene-butadiene rubber carboxymethyl cellulose (SBR-CMC) backbone.

19. The method of claim 15, wherein the polymer binder is prepared by reacting a functional group of the backbone of the polymer binder with a detectable reagent to form the detectable label that is bonded to the backbone of the polymer binder.

20. The method of claim 15, excluding a fluorinated binder.
